(19) United States
(12) Patent Application Publication
(10) Pub. No.: US 2006/0095283 A1
(43) Pub. Date: May 4, 2006

(54) Servicer linkage system, portfolio generation support system, portfolio generation support method, relay computer and recording medium

(75) Inventors: Yasuhide Matsumoto, Kawasaki (JP); Tatsuro Matsumoto, Kawasaki (JP); Hideto Kihara, Kawasaki (JP); Satoru Watanabe, Kawasaki (JP); Masayuki Fukui, Kawasaki (JP); Ai Yano, Kawasaki (JP); Kazuo Sasaki, Kawasaki (JP); Tamotsu Yokota, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/087,661

(22) Filed: Mar. 24, 2005

(30) Foreign Application Priority Data
Oct. 28, 2004 (JP) 2004-314635

(51) Int. Cl. G06Q 99/00

(52) U.S. Cl. 705/1

(57) ABSTRACT

Provided are a servicer linkage system, a portfolio generation support system, a portfolio generation support method, a relay computer and recording medium storing a computer program capable of deciding an appropriate combination of financial products and specifying the trading order thereof. A relay computer connected with dealer computers and a user computer to transmit/receive data stores first financial product information including information for sorting a financial product selected at a predetermined time point, and the amount and the component ratio of said financial product, accepts second financial product information including information for sorting a target financial product, and the amount and the component ratio of the target financial product, calculates differential data of the first and the second financial product information and specifies the updating order of a financial product included in the first financial product information to a financial product included in the second financial product information.

### CROSS-REFERENCE TO RELATED APPLICATIONS

This Nonprovisional application claims priority under 35 U. S. C. §119(a) on Patent Application No. 2004-314635 filed in Japan on Oct. 28, 2004, the entire contents of which are hereby incorporated by reference.

### BACKGROUND OF THE INVENTION

The present invention relates to a servicer linkage system, a portfolio generation support system, a portfolio generation support method, a relay computer and a computer program for combining services (financial products) provided by a plurality of servicers (financial products provider) connected with each other via communication means and linking the services (giving an instruction on trading) on the basis of the structure of the incoming context data (portfolio plan).

With the rapid progress of computer technology in recent years, the computerization of the financial system has advanced and many applications applicable to the retail service have been developed such as optimization of financial asset management and generation of an optimization portfolio.

For example, disclosed in Japanese Patent Application Laid-Open No. 2002-269392 is a purchase agent support server using the Internet which has an agent function for gathering information on a plurality of financial products and providing a customer with an appropriate combination. In this manner, the customer can extract products appropriate for himself easily from a variety of financial products.

Disclosed in Japanese Patent Application Laid-Open No. 2004-127260 is a securities trading fund loan method constructed to make a loan automatically from a financial institution in online securities service via the Internet when a customer runs short of funds for purchasing securities. With this method, the customer can continue an aggressive investment activity without being concerned about the balance of his account of the financial institution.

Disclosed in Japanese Patent Application Laid-Open No. 2002-041804 is an investment advising system for doing optimization simulations of a portfolio and notifying a customer of the situation when a predetermined condition is exceeded, i.e., when the variation in the portfolio increases exceeding a desired predictor. With this system, the customer can receive a warning of some kind when the fact is detected that his portfolio has veered far from the desired portfolio plan, in order not to miss the opportunity to review the incoming portfolio or the like.

### BRIEF SUMMARY OF THE INVENTION

The present invention has been made in view of such circumstances, and it is an object thereof to provide a servicer linkage system, a portfolio generation support system, a portfolio generation support method, a relay computer and a recording medium capable of deciding an appropriate combination of a plurality of financial products and specifying the trading order thereof.

Another object of the present invention is to provide a servicer linkage system, a portfolio generation support system, a portfolio generation support method, a relay computer and a recording medium capable of generating a monitoring condition for judging whether a planned incoming portfolio can be realized or not in the course of generation of the portfolio.

In order to achieve the objects mentioned above, a servicer linkage system according to the first invention is a servicer linkage system comprising: a plurality of service providing computers for providing one or a plurality of services; a service receiving computer which selects a service to be provided and receives the service; and a relay computer which is connected with the plurality of service providing computers and the service receiving computer so as to transmit and receive data via communication means, characterized in that the relay computer comprises: means for storing in storage means first context data for each service receiving computer including the types and the combination of the services selected by the service receiving computer at a predetermined time point; means for accepting from the service receiving computer second context data including the types and the combination of target services; means for calculating differential data of the first context data and the second context data; and means for specifying the order of updating of a service included in the first context data to a service included in the second context data, on the basis of the calculated differential data.

A portfolio generation support system according to the second invention is a portfolio generation support system for supporting generation of a portfolio of a financial product, comprising: a plurality of dealer computers for providing one or a plurality of financial products; a user computer for accepting an instruction for selecting a financial product to be provided and making a trade; and a relay computer which is connected with the plurality of dealer computers and the user computer so as to transmit and receive data via communication means, characterized in that the relay computer comprises: means for storing in storage means first financial product information for each user computer including information for sorting a financial product selected at a predetermined time point, and the amount and the component ratio of the financial product thus selected; means for accepting from the user computer second financial product information including information for sorting a target financial product, the amount and the component ratio of the target financial product; means for calculating differential data of the first financial product information and the second financial product information; and means for specifying the order of updating of a financial product included in the first financial product information to a financial product included in the second financial product information, on the basis of the calculated differential data.

A portfolio generation support system according to the third invention is a system of the second invention, characterized in that the relay computer further comprises: means for generating a monitoring condition for monitoring the state transition from the first financial product information to the second financial product information on the basis of the differential data; and means for storing the monitoring condition generated by said means in relation to the second financial product information.

A portfolio generation support system according to the fourth invention is a system of the second invention, characterized in that the relay computer stores in storage means third financial product information including information for sorting a plurality of financial products, and the amount and the component ratio each of the financial products in relation to the monitoring condition, and further comprises: means for calculating the similarity between each of a plurality of pieces of stored third financial product information and the second financial product information; means for extracting a monitoring condition stored in relation to a piece of third financial product information having the highest similarity; and means for storing the monitoring condition extracted by said means in relation to the second financial product information.

A portfolio generation support system according to the fifth invention is a system of any one of the second to fourth inventions, characterized in that the information for sorting the financial product includes distinction between illiquidity asset and liquidity asset and an indicator of the degree of cashability of the liquidity asset.

A portfolio generation support system according to the sixth invention is a portfolio generation support system for supporting generation of a portfolio of a financial product with a relay computer which is connected with a plurality of dealer computers for providing one or a plurality of financial products and a user computer which accepts an instruction for selecting a financial product to be provided and making a trade so as to transmit and receive data via communication means, characterized in that the relay computer: stores in storage means first financial product information for each user computer including information for sorting a financial product selected at a predetermined time point, and the amount and the component ratio of the financial product thus selected; accepts from the user computer second financial product information including information for sorting a target financial product, the amount and the component ratio of the target financial product; calculates differential data of the first financial product information and the second financial product information; and specifies the order of updating of a financial product included in the first financial product information to a financial product included in the second financial product information on the basis of the calculated differential data.

A relay computer according to the seventh invention is a relay computer for supporting generation of a portfolio of a financial product, which is connected with a plurality of dealer computers for providing one or a plurality of financial products and a user computer which accepts an instruction for selecting a financial product to be provided and making a trade so as to transmit and receive data via communication means, characterized by comprising: means for storing in storage means first financial product information for each user computer including information for sorting a financial product selected at a predetermined time point, and the amount and the component ratio of the financial product thus selected; means for accepting from the user computer second financial product information including information for sorting a target financial product, and the amount and the component ratio of the target financial product; means for calculating differential data of the first financial product information and the second financial product information; and means for specifying the order of updating of a financial product included in the first financial product information to a financial product included in the second financial product information on the basis of the calculated differential data.

A recording medium according to the eighth invention is a recording medium containing a computer program executable by a relay computer for supporting generation of a portfolio of a financial product, which relay computer is connected with a plurality of dealer computers for providing one or a plurality of financial products and a user computer which accepts an instruction for selecting a financial product to be provided and making a trade so as to transmit and receive data via communication means, characterized by causing the relay computer to function as: means for storing in storage means first financial product information for each user computer including information for sorting a financial product selected at a predetermined time point, and the amount and the component ratio of a financial product thus selected; means for accepting from the user computer second financial product information including information for sorting a target financial product, and the amount and the component ratio of the target financial product; means for calculating differential data of the first financial product information and the second financial product information; and means for specifying the order of updating of a financial product included in the first financial product information to a financial product included in the second financial product information on the basis of the calculated differential data.

In the first invention, a relay computer for relaying a service which can be received from a plurality of service providing computers for providing a service to a service receiving computer: stores first context data for each service receiving computer indicative of the content of a service selected by the service receiving computer at a predetermined time point; calculates differential data of the first context data and a target second context data; and specifies the order of utilizing a service included in the first context data and a service included in the second context data. In this manner, in addition to updating the combination of services which can be received by the service receiving computer, it is enabled to decide the order of utilizing the combined services so that the service receiving computer can receive services in the most effective manner.

In the second invention and the sixth to eighth inventions, a relay computer for providing a user computer with financial products which can be provided from a plurality of dealer computers for providing a financial product in an aggregate form: stores first financial product information (current portfolio) for each user computer indicative of the combination of financial products selected by the user computer at a predetermined time point; calculates differential data of the first financial product information and the second financial product information (incoming portfolio) indicative of the combination of target financial products; and specifies the order of updating of the structure of a financial product included in the first financial product information to the combination of financial products included in the second financial product information. In this manner, in addition to updating the combination of financial products, it is enabled in the portfolio updating procedure to decide the order of updating of a portfolio so that the user computer can update a portfolio in the most effective manner, i.e., so that the cash flow is prevented from going bankrupt in the course of updating to the incoming portfolio and the marginal gain in trading can be maximized.

In the third invention, a monitoring condition for monitoring the state transition of financial product information is generated on the basis of differential data of first financial product information (current portfolio) indicative of the combination of financial products selected by the user computer at a predetermined time point and second financial product information (incoming portfolio) indicative of the combination of target financial products, and the generated monitoring condition is stored in relation to the second financial product information. In this manner, it is possible to generate a monitoring condition for judging whether the incoming portfolio can be realized or not in the course of generation of the portfolio on the basis of the differential data, it is possible to judge accurately whether updating to the incoming portfolio is possible or not by grasping the transition state to the incoming portfolio using the monitoring condition based on information having a marked differential between the current portfolio and the incoming portfolio, and it is possible to judge further accurately whether the portfolio plan is to be changed or not.

In the fourth invention, the similarity between each piece of third financial product information (sample portfolio) indicative of the combination of a plurality of financial products and the second financial product information (incoming portfolio) indicative of the combination of target financial products accepted from the user computer is calculated, and a monitoring condition stored in relation to third financial product information having the highest similarity is used as a monitoring condition for the transition state from the first financial product information (current portfolio) to the second financial product information (incoming portfolio). In this manner, by grasping the transition state to the incoming portfolio using a monitoring condition set for the sample portfolio most similar to the incoming portfolio among preliminarily stored sample portfolios as a monitoring condition for judging whether the incoming portfolio can be realized or not in the course of generation of the portfolio, it is unnecessary to calculate a complex monitoring condition again, so that it is enabled to judge whether updating to the incoming portfolio is possible or not while reducing the used amount of the computer resources such as a CPU or a memory.

In the fifth invention, the information for sorting a financial product includes distinction between illiquidity asset and liquidity asset and an indicator of the degree of cashability of the liquidity asset. In this manner, it is possible to decide the order of updating from the current portfolio to the incoming portfolio according to the degree of cashability, it is possible to prevent, for example, the cash flow from going bankrupt in the course of updating, and it is enabled to maximize the marginal gain in trading.

With the first invention, in addition to updating the combination of services which can be received by the service receiving computer, it is enabled to decide the order of utilizing the combined services so that the service receiving computer can receive services in the most effective manner.

With the second invention and the sixth to eighth inventions, in addition to updating the combination of financial products, it is enabled in the portfolio updating procedure to decide the order of updating of a portfolio so that the user computer can update a portfolio in the most effective manner, i.e., so that the cash flow is prevented from going bankrupt in the course of updating to the incoming portfolio and the marginal gain in trading can be maximized.

With the third invention, it is possible to generate a monitoring condition for judging whether the incoming portfolio can be realized or not in the course of generation of the portfolio on the basis of the differential data, it is possible to judge accurately whether updating to the incoming portfolio is possible or not by grasping the transition state to the incoming portfolio using the monitoring condition based on information having a marked differential between the current portfolio and the incoming portfolio, and it is possible to judge further accurately, for example, whether the portfolio plan is to be changed or not.

With the fourth invention, by grasping the transition state to the incoming portfolio using a monitoring condition set for the sample portfolio most similar to the incoming portfolio among preliminarily stored sample portfolios as a monitoring condition for judging whether the incoming portfolio can be realized or not in the course of generation of the portfolio, it is unnecessary to calculate a complex monitoring condition again, so that it is enabled to judge whether updating to the incoming portfolio is possible or not while reducing the used amount of the computer resources such as a CPU or a memory.

With the fifth invention, it is possible to decide the order of updating from the current portfolio to the incoming portfolio according to the degree of cashability, it is possible to prevent, for example, the cash flow from going bankrupt in the course of updating, and it is enabled to maximize the marginal gain in trading.

The above and further objects and features of the invention will more fully be apparent from the following detailed description with accompanying drawings.

### BRIEF DESCRIPTION OF THE SEVERAL VIEWS OF THE DRAWINGS

FIG. 1 is a block diagram showing the structure of a servicer linkage system according to Embodiment 1 of the present invention;

FIG. 2 is a block diagram showing the structure of a relay computer in the servicer linkage system according to Embodiment 1 of the present invention;

FIGS. 3A through 3C are views showing an example of a service combination model of the servicer linkage system according to Embodiment 1 of the present invention;

FIG. 4 is a flow chart showing the process procedure of a CPU of the relay computer in the servicer linkage system according to Embodiment 1 of the present invention;

FIG. 5 is a block diagram showing the structure of a portfolio generation support system according to Embodiment 2 of the present invention;

FIG. 6 is a block diagram showing the structure of a relay computer in the portfolio generation support system according to Embodiment 2 of the present invention;

FIG. 7 is a view showing an example of a current portfolio of the portfolio generation support system according to Embodiment 2 of the present invention;

FIG. 8 is a view showing an example of asset component ratio of an incoming portfolio inputted through a user computer in the portfolio generation support system according to Embodiment 2 of the present invention;

FIG. 9 is a view showing an example of an XML document of a current portfolio stored as financial product information of the portfolio generation support system according to Embodiment 2 of the present invention;

FIG. 10 is a view showing an example of an XML document of an incoming portfolio stored in a RAM in the portfolio generation support system according to Embodiment 2 of the present invention;

FIG. 11 is a view showing an example of an XML document indicative of a differential between a current portfolio and an incoming portfolio of the portfolio generation support system according to Embodiment 2 of the present invention;

FIG. 12 is a view showing an example of differential data for the case of updating of a current portfolio to an incoming portfolio of the portfolio generation support system according to Embodiment 2 of the present invention;

FIG. 13 is a view showing the order of updating from a current portfolio to an incoming portfolio of the portfolio generation support system according to Embodiment 2 of the present invention;

FIG. 14 is a flow chart showing the process procedure of a CPU of the relay computer in the portfolio generation support system according to Embodiment 2 of the present invention;

FIG. 15 is a block diagram showing the structure of a relay computer in a portfolio generation support system according to Embodiment 3 of the present invention;

FIG. 16 is a conceptual diagram of an updating model from a current portfolio to a target incoming portfolio;

FIG. 17 is a flow chart showing the process procedure of a CPU of the relay computer in the portfolio generation support system according to Embodiment 3 of the present invention;

FIG. 18 is a view illustrating a screen for accepting a portfolio updating simulation condition;

FIG. 19 is a view illustrating a monitoring condition of a portfolio updating state;

FIG. 20 is a view showing an example of portfolio information stored in storage means in the portfolio generation support system according to Embodiment 3 of the present invention; and

FIG. 21 is a flow chart showing the process procedure of the CPU of the relay computer in the portfolio generation support system according to Embodiment 3 of the present invention for deciding a monitoring condition on the basis of the similarity.

### DETAILED DESCRIPTION OF THE INVENTION

As described above, the purchase agent support server disclosed in Japanese Patent Application Laid-Open No. 2002-269392 only combines financial products in order to generate a portfolio and cannot decide the order of selling or purchasing of the financial products related to the combination. Consequently, there is a problem that a portfolio selected by the agent might not be realized since the cash flow may be temporally overdrawn even when appropriate products can be selected.

Though the above problem might be solved when using a securities trading fund loan method disclosed in Japanese Patent Application Laid-Open No. 2004-127260 together, it is still an insufficient solution in view of the interest burden. Moreover, since more cashable products and less cashable products are mixed in the financial products, the possibility of the cash flow of going bankrupt due to timing difference is further increased when trading indications are uniformly given.

Moreover, with the investment advising system disclosed in Japanese Patent Application Laid-Open No. 2002-041804, though it is possible to perform optimization simulations of a cash flow portfolio according to an appropriate combination of a plurality of financial products, a specific example for setting a notification condition (monitoring condition) for the user including the variation of the portfolio is not disclosed and how to decide the notification condition (monitoring condition) appropriately is the most difficult task.

The present invention has been made with the aim of solving the above problems, and it is an object thereof to provide a servicer linkage system, a portfolio generation support system, a portfolio generation support method, a relay computer and a computer program capable of deciding an appropriate combination of a plurality of financial products and specifying the trading order thereof.

Another object of the present invention is to provide a servicer linkage system, a portfolio generation support system, a portfolio generation support method, a relay computer and a computer program capable of generating a monitoring condition for judging whether a planned incoming portfolio can be realized or not in the course of generation of the portfolio, which are realized with the following embodiments.

### Embodiment 1

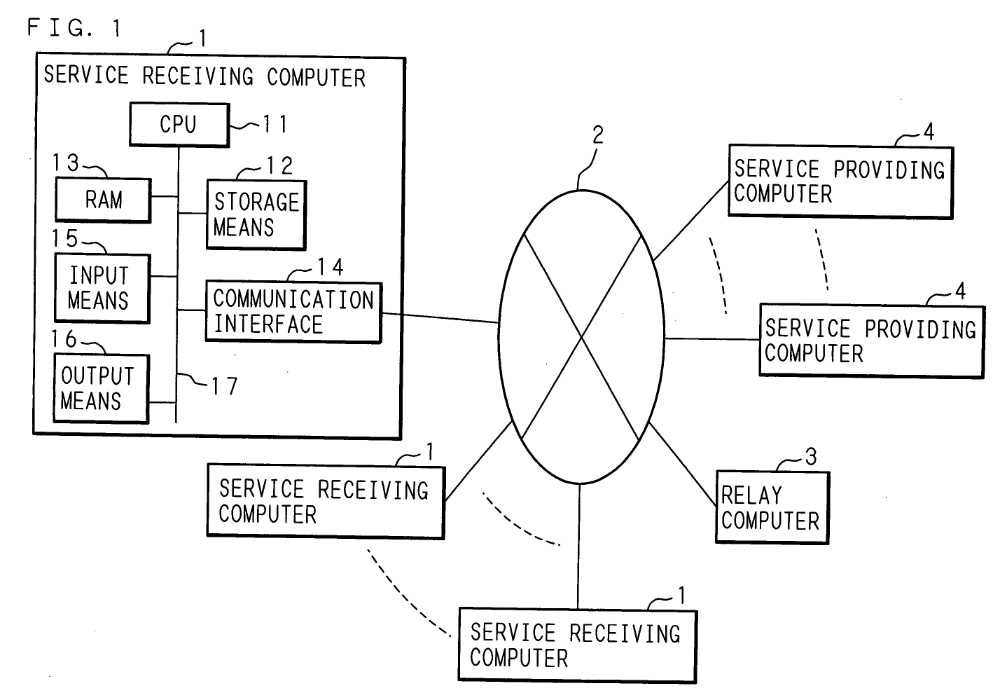

The following description will explain a servicer linkage system according to Embodiment 1 of the present invention in the concrete with reference to the drawings. FIG. 1 is a block diagram showing the structure of the servicer linkage system according to Embodiment 1 of the present invention. In this Embodiment 1, a plurality of service receiving computers 1, 1, . . . , a relay computer 3 and service providing computers 4, 4, . . . related to service dealers for providing services of the same type or of different types are connected via the Internet 2 so as to transmit/receive data to/from each other.

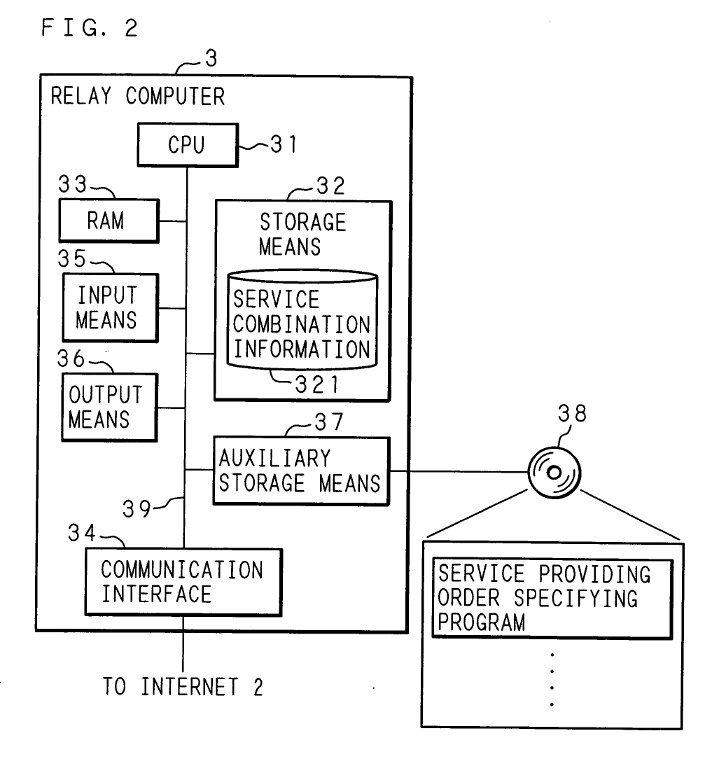

FIG. 2 is a block diagram showing the structure of the relay computer 3 in the servicer linkage system according to Embodiment 1 of the present invention. The relay computer 3 is composed of, at least, a CPU (central processing unit) 31, storage means 32, a RAM 33, a communication interface 34 to be connected with outer communication means such as the Internet 2, input means 35, output means 36 and auxiliary storage means 37 constituted of a portable recording medium 38 such as a DVD or a CD.

The CPU 31, which is connected with the respective hardware units of the relay computer 3 mentioned above via an internal bus 39, controls the above respective hardware units and executes various software functions according to a process program stored in the storage means 32, e.g., a program for specifying the order of providing a plurality of services to be provided from the service providing computers 4, 4, . . . .

The storage means 32, which is composed of a built-in fixed storage device (hard disk), a ROM and the like, stores a process program, which is obtained from an outer computer via the communication interface 34 or from the portable recording medium 38 such as a DVD or a CD-ROM, necessary for causing a computer to function as the relay computer 3. In addition to the process program, the storage means 32 stores, for example, service combination information 321 which is sample data of a combination of a plurality of services to be provided from the service providing computers 4, 4, . . . .

The RAM 33, which is constituted of a DRAM or the like, stores temporary data which occurs in execution of software. The communication interface 34, which is connected with the inner bus 39, transmits and receives data necessary for the process when being connected with the Internet 2 or the like in a communicable manner.

The input means 35 is a pointing device such as a mouse for selecting a word displayed on the screen, a keyboard for inputting text data on the screen by keying, or the like. The output means 36 is a display such as a liquidity crystal display (LCD) for displaying an image or a display device (CRT).

The auxiliary storage means 37, which is constituted of a portable recording medium 38 such as a CD or a DVD, downloads to the storage means 32 a program, data or the like to be processed by the CPU 31. The auxiliary storage means 37 also can write data processed by the CPU 31 in order to do a backup.

Each of a plurality of service receiving computers 1, 1, . . . according to this Embodiment 1 is composed of, at least, a CPU (central processing unit) 11, storage means 12, a RAM 13, a communication interface 14 to be connected with outer communication means such as the Internet 2, input means 15 and output means 16.

The CPU 11, which is connected with the respective hardware units of the service receiving computer 1 mentioned above via an inner bus 17, controls the above respective hardware units and executes various software functions according to a program stored in the storage means 12, e.g., a web browser for executing a plurality of services to be provided from the service providing computers 4, 4, . . . .

The storage means 12, which is composed of a built-in fixed storage device (hard disk), a ROM and the like, stores a program such as a browser necessary for causing a computer to function as the service receiving computer 1. The RAM 13, which is constituted of a DRAM or the like, stores temporary data which occurs in execution of software. The communication interface 14, which is connected with the inner bus 17, transmits and receives data necessary for a process when being connected with the Internet 2 or the like in a communicable manner.

The input means 15 is a pointing device such as a mouse for selecting a word displayed on the screen, a keyboard for inputting text data on the screen by keying, or the like. The output means 16 is a display such as a liquidity crystal display (LCD) for displaying an image or a display device (CRT).

The relay computer 3 accepts from the service receiving computer 1 service specifying information for specifying what type of service among a plurality of services to be provided by the service providing computers 4, 4, . . . is desired to be received on what condition. More specifically, the relay computer 3 accepts an input of information for specifying the type of a service, an input of the component ratio of each service type to the entire services to be received, an input of the total price of the entire services to be received, and the like. The information to be accepted is not limited to this but may be information for specifying a dealer for providing a service or information for accepting specification of the price of a service to be provided.

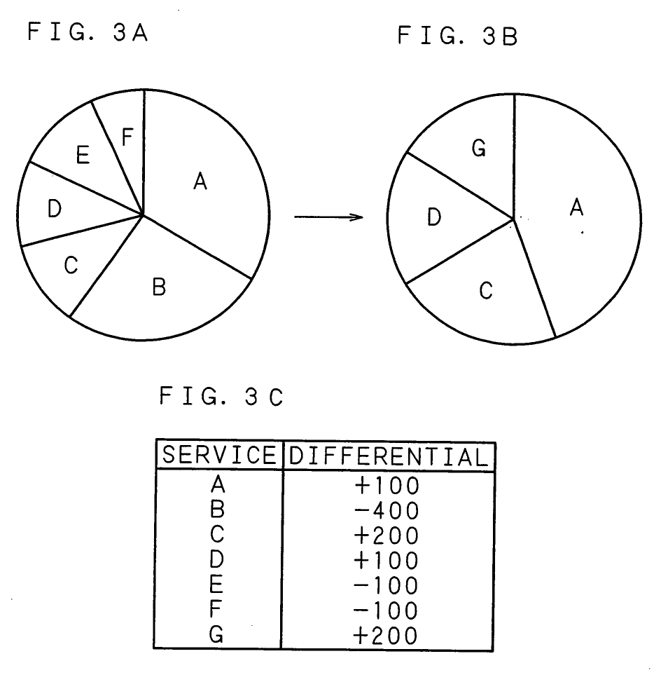

The relay computer 3 constructs a service combination model related to a combination of a plurality of services desired to be provided on the basis of the accepted service specifying information and calculates a differential between the constructed service combination model and a current service combination model. FIG. 3A, FIG. 3B and FIG. 3C are views showing an example of a service structure model of the servicer linkage system according to Embodiment 1 of the present invention. In the example shown in FIG. 3A, FIG. 3B and FIG. 3C, the size of the circle denotes the total price for receiving services, each sector of the circle graph denotes a ratio of each price for each service to the total price, FIG. 3A denotes the current service combination model and FIG. 3B denotes a service combination model corresponding to the accepted service specifying information.

It can be seen that the services to be provided via the service receiving computer 1 currently are of six types of A, B, C, D, E and F while the desired services accepted from the service receiving computer 1 are of four types of A, C, D and G, and the total price for receiving services do not vary while the component ratio of a service price varies.

The relay computer 3 calculates differential data of the current service combination model and the service combination model corresponding to the service specifying information and specifies the order of updating of the current service combination model to the service combination model corresponding to the service specifying information. In FIG. 3A, FIG. 3B and FIG. 3C, for example, when the price for receiving the service A is increased first, the total amount of payment temporarily exceeds the total price of the current service combination model. Consequently, an insolvency state might occur.

In order to avoid such a state, the current service combination model and the service combination model corresponding to the specifying information are compared to calculate a differential, for example. FIG. 3C is a view showing a price differential between the current service combination model and the service combination model corresponding to the service specifying information. As shown in FIG. 3C, the differential amount is calculated for each service type and the order of updating of the current service combination model to the service combination model corresponding to the specifying information is specified. More specifically, an order such that the amount of contract of the service A is increased after canceling the contract of the service E, an order such that the service G is newly contracted after canceling the contract of the service B, or the like is specified.

Though the above description explains a case of specifying the order of updating so that the cash flow is kept from being overdrawn, the present invention is not limited to this, but various order specifying conditions may be added according to the characteristics of the service.

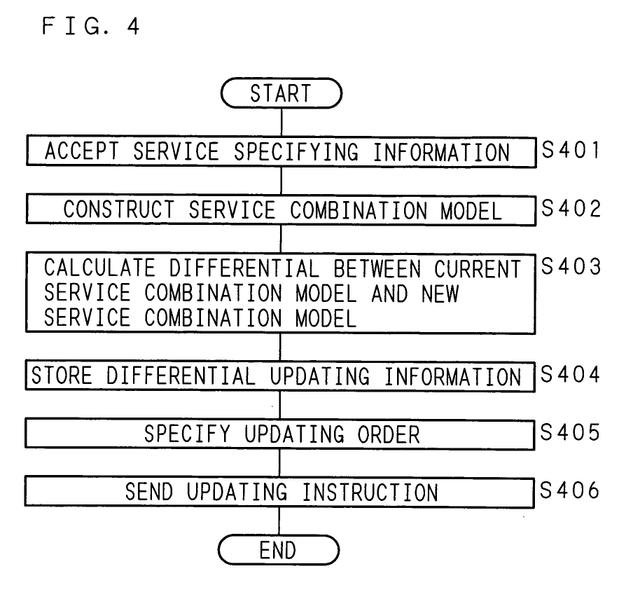

FIG. 4 is a flow chart showing the process procedure of the CPU 31 of the relay computer 3 in the servicer linkage system according to Embodiment 1 of the present invention. The CPU 31 of the relay computer 3 accepts service specifying information for specifying what type of service among a plurality of services to be provided by the service providing computers 4, 4, . . . is desired to be received on what condition (step S401). On the basis of the accepted service specifying information, the CPU 31 constructs a corresponding service combination model (step S402).

The CPU 31 of the relay computer 3 calculates a differential between the current service combination model and the newly constructed service combination model (step S403) and stores in the RAM 33 differential updating information which is information on contract of a new service, cancellation of an existing service and an increase or decrease of, for example, the contact rate of an existing service (step S404).

The CPU 31 of the relay computer 3 specifies the order of updating from the current service combination model to the newly constructed service combination model in order not to exceed the total price of the current service combination model (step S405). The CPU 31 sends to each service receiving computer 1 an instruction for updating a service combination model according to the specified order (step S406).

As described above, with this Embodiment 1, in addition to updating the combination of services which is desired by the user of the service receiving computer 1, it is enabled to specify the order of updating of the combination of services so that the user of the service receiving computer 1 can receive services in the most effective manner.

It should be noted that the present invention is not limited to acceptance of service specifying information for specifying what type of service among a plurality of services is desired to be received on what condition, but the storage means 32, for example, may store service combination information 321 which is sample data of a combination of a plurality of services so that the user of the service receiving computer 1 may select sample data most similar to the one he desires.

### Embodiment 2

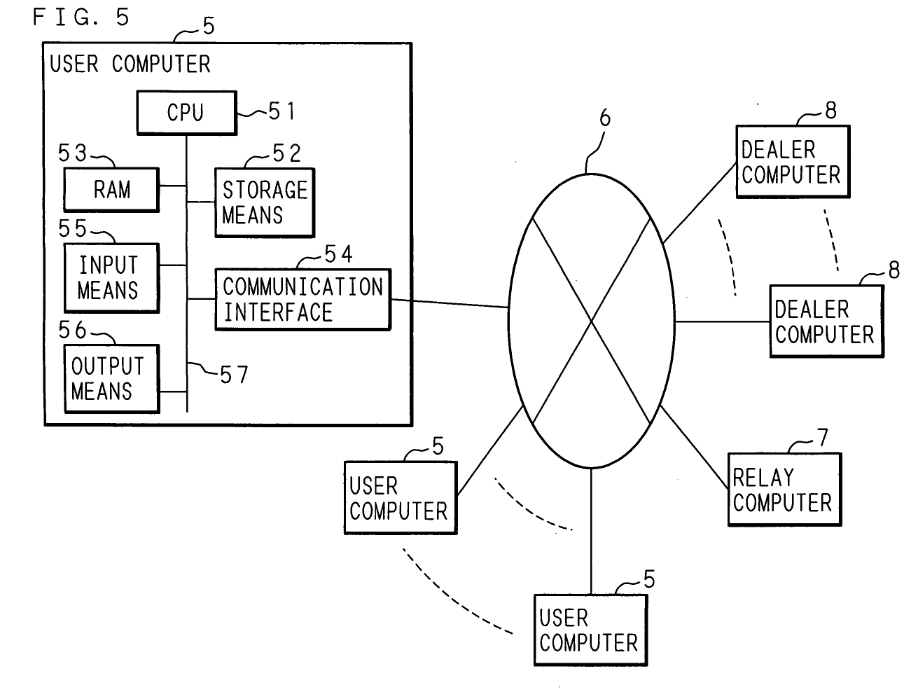

The following description will explain a portfolio generation support system according to Embodiment 2 of the present invention in the concrete with reference to the drawings. FIG. 5 is a block diagram showing the structure of a portfolio generation support system according to Embodiment 2 of the present invention. In this Embodiment 2, a plurality of user computers 5, 5, . . . , a relay computer 7 and dealer computers 8, 8, . . . related to dealers such as financial institutions for respectively providing a plurality of financial products are connected via the Internet 6 so as to transmit/receive data to/from each other.

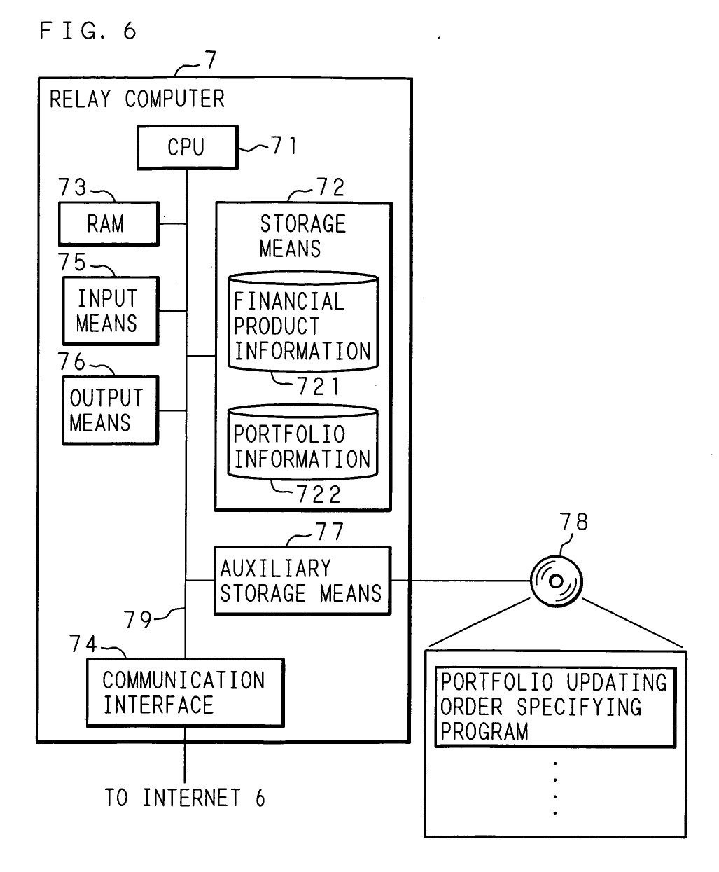

FIG. 6 is a block diagram showing the structure of the relay computer 7 in the portfolio generation support system according to Embodiment 2 of the present invention. The relay computer 7 is composed of, at least, a CPU (central processing unit) 71, storage means 72, a RAM 73, a communication interface 74 to be connected with outer communication means such as the Internet 6, input means 75, output means 76 and auxiliary storage means 77 constituted of a portable recording medium 78 such as a DVD or a CD.

The CPU 71, which is connected with the respective hardware units of the relay computer 7 mentioned above via an internal bus 79, controls the above respective hardware units and executes various software functions according to a process program stored in the storage means 72, e.g., a program for specifying the order of updating of a portfolio including a plurality of financial products to be provided from the dealer computers 8, 8, . . . .

The storage means 72, which is composed of a built-in fixed storage device (hard disk), a ROM and the like, stores a process program, which is obtained from an outer computer via the communication interface 74 or from the portable recording medium 78 such as a DVD or a CD-ROM, necessary for causing a computer to function as the relay computer 7. In addition to the process program, the storage means 72 stores, for example, financial product information 721 which is information on a plurality of financial products to be provided from the dealer computers 8, 8, . . . and portfolio information 722 which is a sample portfolio of a combination of financial products.

The RAM 73, which is constituted of a DRAM or the like, stores temporary data which occurs in execution of software. The communication interface 74, which is connected with the inner bus 79, transmits and receives data necessary for the process when being connected with the Internet 6 or the like in a communicable manner.

The input means 75 is a pointing device such as a mouse for selecting a word displayed on the screen, a keyboard for inputting text data on the screen by keying, or the like. The output means 76 is a display such as a liquidity crystal display (LCD) for displaying an image or a display device (CRT).

The auxiliary storage means 77, which is constituted of a portable recording medium 78 such as a CD or a DVD, downloads to the storage means 72 a program, data or the like to be processed by the CPU 71. The auxiliary storage means 77 also can write data processed by the CPU 71 in order to do a backup.

Each of a plurality of user computers 5, 5, . . . according to this Embodiment 2 is composed of, at least, a CPU (central processing unit) 51, storage means 52, a RAM 53, a communication interface 54 to be connected with outer communication means such as the Internet 6, input means 55 and output means 56.

The CPU 51, which is connected with the respective hardware units of the user computer 5 mentioned above via an inner bus 57, controls the above respective hardware units and executes various software functions according to a program stored in the storage means 52, e.g., a web browser capable of selecting a plurality of financial products to be provided from the dealer computers 8, 8, . . . .

The storage means 52, which is composed of a built-in fixed storage device (hard disk), a ROM and the like, stores a program such as a browser necessary for causing a computer to function as the user computer 5. The RAM 53, which is constituted of a DRAM or the like, stores temporary data which occurs in execution of software. The communication interface 54, which is connected with the inner bus 57, transmits and receives data necessary for a process when being connected with the Internet 6 or the like in a communicable manner.

The input means 55 is a pointing device such as a mouse for selecting a word displayed on the screen, a keyboard for inputting text data on the screen by keying, or the like. The output means 56 is a display such as a liquidity crystal display (LCD) for displaying an image or a display device (CRT).

The relay computer 7 accepts, from a user computer 5 related to a user, financial product information for specifying what type of financial product among a plurality of financial products to be provided by the dealer computers 8, 8, . . . is desired to be traded on what condition. More specifically, the relay computer 7 accepts information for specifying the type of a financial product, the transaction amount ratio of each financial product type to the entire transaction, the total amount of transaction of the financial products and the like.

The financial product information accepted by the relay computer 7 is not limited to the information mentioned above, but may be information for directly specifying a financial product dealer, such as a bank or a securities firm for providing financial products, or information for directly specifying a financial product to be provided.

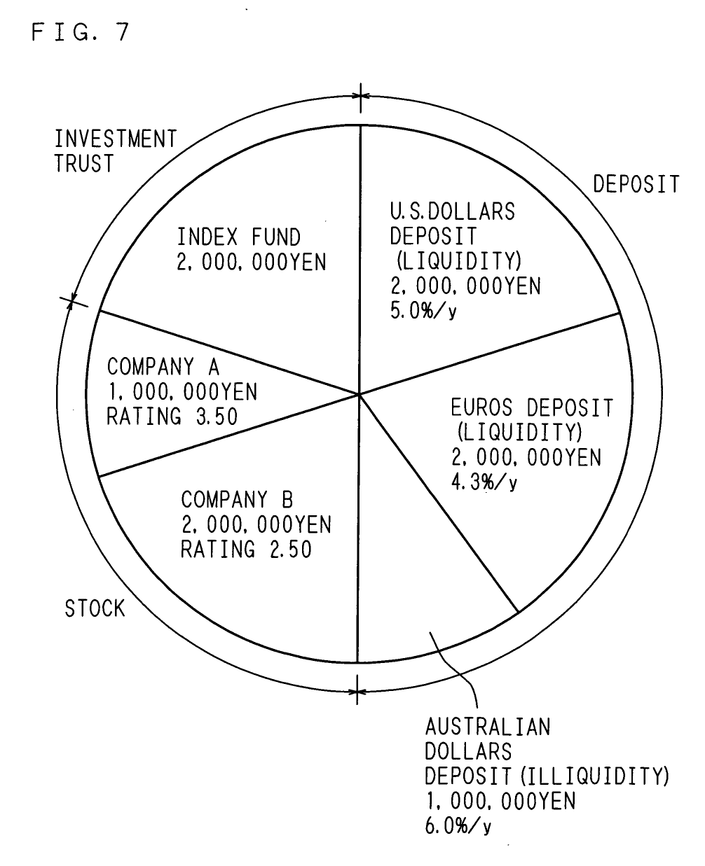

The relay computer 7 generates an incoming portfolio related to a combination of a plurality of financial products, which the user desires to trade, on the basis of the accepted financial product information and calculates a differential between the generated incoming portfolio and a current portfolio. FIG. 7 is a view showing an example of a current portfolio of the portfolio generation support system according to Embodiment 2 of the present invention. In the example shown in FIG. 7, financial products subject to trading are divided into four types: deposit (liquidity deposit, illiquidity deposit), stock and investment trust. The size of the circle denotes the total asset obtained by purchasing the financial products and each sector of the circle graph denotes a ratio of each asset for each financial product to the total asset.

For the sake of simplifying an explanation on the portfolio updating process, the following description will explain a case where the financial product types subject to trading by the user via the user computer 5 are not updated with a current portfolio and an incoming portfolio and the asset component ratio of a financial product is updated. It should be understood that the number of the financial product types may be increased or decreased.

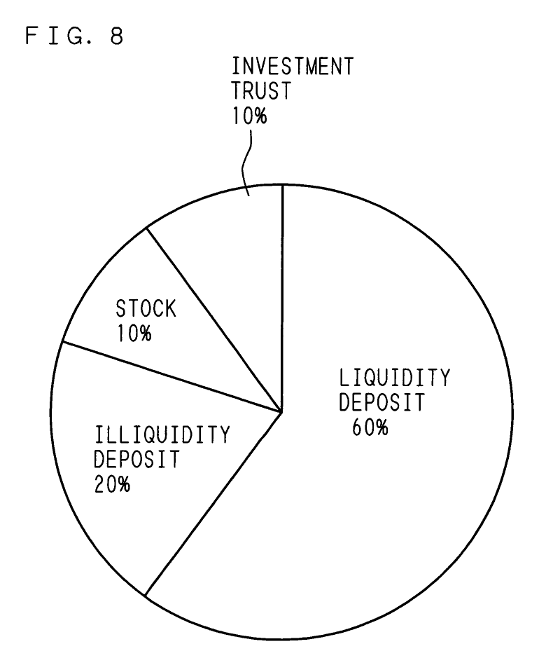

FIG. 8 is a view showing an example of the asset component ratio of an incoming portfolio inputted through the user computer 5 in the portfolio generation support system according to Embodiment 2 of the present invention. In the example shown in FIG. 8, the component ratio of deposit in the incoming portfolio is increased and the component ratio of stock and investment trust is decreased.

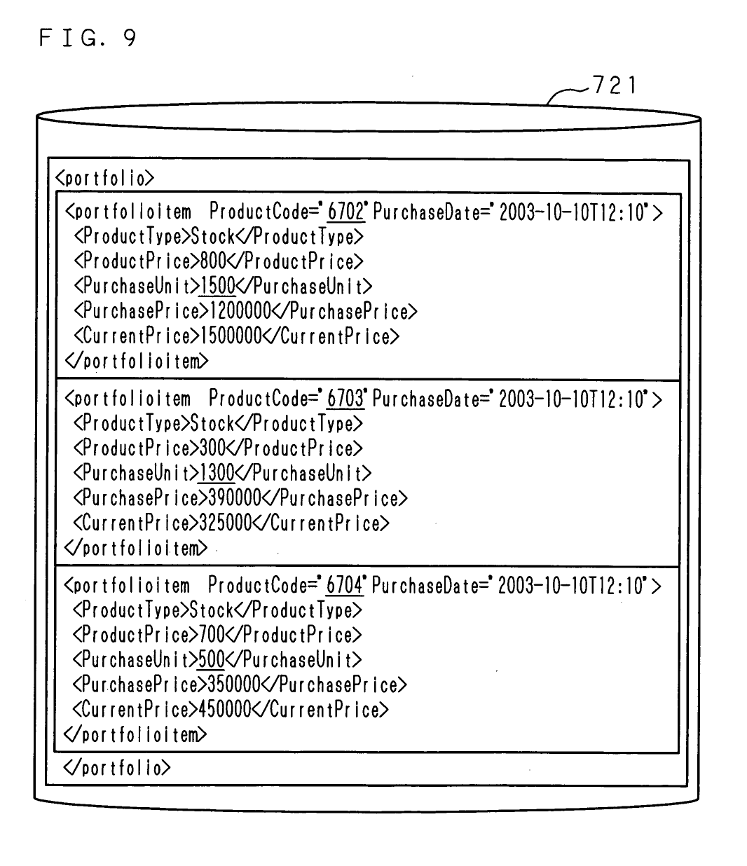

The relay computer 7 obtains information for each user of a dealer computer 8 on a financial product which can be provided to the user of the user computer 5 from a plurality of dealer computers 8, 8, . . . and stores the information as financial product information 721 of the storage means 72. FIG. 9 is a view showing an example of an XML document of a current portfolio stored as the financial product information 721 of the portfolio generation support system according to Embodiment 2 of the present invention.

FIG. 9 shows the entire structure of a portfolio by showing the type of a financial product (ProductType) such as liquidity deposit, illiquidity deposit, stock and investment trust, the unit price at the time of purchase (ProductPrice), the purchase unit (PurchaseUnit), the purchased amount (PurchasePrice) and the current price (CurrentPrice) for each product code (ProductCode) which is information for identifying an obtained financial product. FIG. 9 specifically shows a case where the type of the financial product is a “stock”. When the type of the financial product (ProductType) is saving deposit, the current price (CurrentPrice) is calculated by adding an interest to the amount of deposit while, when the type of the financial product (ProductType) is investment trust, the current price (CurrentPrice) is calculated by adding an investment return of rating average to the investment.

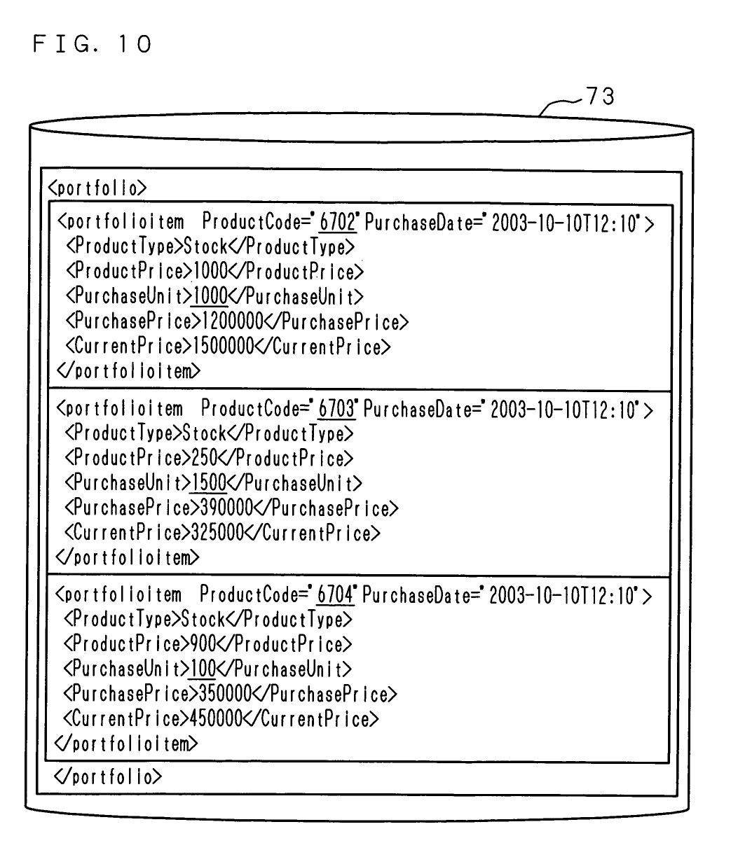

The relay computer 7 accepts the asset component ratio of an incoming portfolio inputted through the user computer 5 and stores the asset component ratio in the RAM 73. FIG. 10 is a view showing an example of an XML document of an incoming portfolio stored in the RAM 73

Similarly to FIG. 9, FIG. 10 shows the entire structure of a portfolio by showing the type of a financial product (Productype) such as liquidity deposit, illiquidity deposit, stock and investment trust, the target unit price (ProductPrice), the purchase unit (PurchaseUnit), the purchased amount (PurchasePrice) and the current price (CurrentPrice) for each product code (ProductCode) which is information for identifying an obtained financial product. Similarly to FIG. 9, FIG. 10 specifically shows a case where the type of the financial product is a “stock”. When the type of the financial product (ProductType) is saving deposit, the current price (CurrentPrice) is calculated by adding an interest to the amount of deposit while, when the type of the financial product (Productype) is investment trust, the current price (CurrentPrice) is calculated by adding an assumed profit of rating average to the investment.

The relay computer 7 calculates a differential between the current portfolio and the incoming portfolio. More specifically, the relay computer 7 compares the XML documents shown in FIGS. 9 and 10 and subtracts the purchase unit (PurchaseUnit) shown in the XML document indicative of the current portfolio from the purchase unit (PurchaseUnit) shown in the XML document indicative of the incoming portfolio, for each product code (ProductCode).

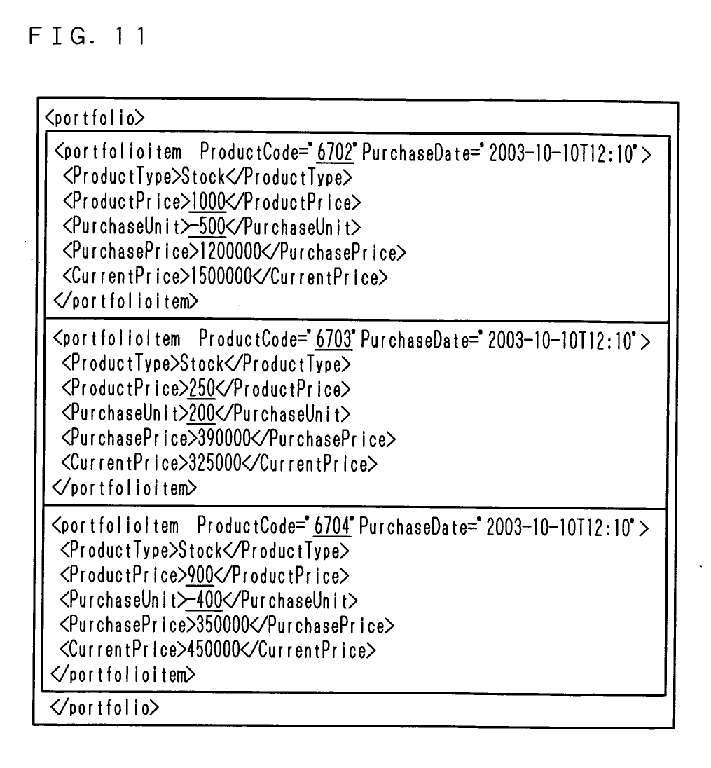

FIG. 11 is a view showing an example of an XML document indicative of a differential between a current portfolio and an incoming portfolio of the portfolio generation support system according to Embodiment 2 of the present invention. The values of the tags other than the purchase unit (PurchaseUnit) are obtained by copying the values of the tags in the XML document indicative of the incoming portfolio and the value of the tag of the purchase unit (PurchaseUnit) is a value obtained by subtracting the purchase unit (PurchaseUnit) shown in the XML document indicative of the current portfolio from the purchase unit (PurchaseUnit) shown in the XML document indicative of the incoming portfolio. In order to realize the incoming portfolio, a financial product corresponding to the product code (ProductCode) is required to be purchased when the purchase unit (PurchaseUnit) is a positive value while a financial product corresponding to the product code (ProductCode) is required to be sold when the purchase unit (PurchaseUnit) is a negative value.

The relay computer 7 then decides the trading order of a financial product to update the portfolio to the incoming portfolio. For example, when updating the current portfolio shown in FIG. 7 to the incoming portfolio shown in FIG. 8, the total asset of the current portfolio is temporarily exceeded as the U.S. dollars deposit or Euros deposit which is liquidity deposit is increased. Consequently, the cash flow might go bankrupt and the liquidity deposit might be rendered unavailable to increase.

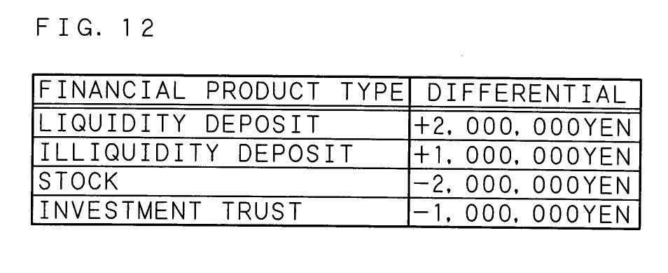

In order to avoid such a state, the trading order of a financial product for updating the portfolio to the incoming portfolio is decided on the basis of the differential between the current portfolio and the incoming portfolio calculated by the relay computer 7. For example, FIG. 12 is a view showing an example of differential data in the case of updating of the current portfolio shown in FIG. 7 to the incoming portfolio shown in FIG. 8 of the portfolio generation support system according to Embodiment 2 of the present invention. As shown in FIG. 12, the liquidity deposit and the illiquidity deposit are required to be increased and the stock and the investment trust are required to be decreased.

The trading order of financial products for updating from the current portfolio to the incoming portfolio is decided in the following manner. In order to prevent the cash flow from going bankrupt, the sale or the cancellation of a financial product is prioritized. That is, an updating process is started from the sale or the cancellation of a financial product, which has a negative differential data value. In the example shown in FIG. 12, the updating process is started from the sale of stock and the cancellation of investment trust. Moreover, the cash flow can be prevented more easily from going bankrupt by prioritizing the sale or the cancellation of a financial product of a larger absolute amount.

Regarding a financial product having a positive differential data value, an updating process is executed by purchase, contract and the like. In the example shown in FIG. 12, the liquidity deposit is increased and the illiquidity deposit is increased. Moreover, by prioritizing the sale or the cancellation of a financial product of a larger absolute amount, the updating process can be shut down in a structure approximated to the incoming portfolio as much as possible and the difference from the assumed marginal gain or loss can be minimized even when the cash flow should go bankrupt.

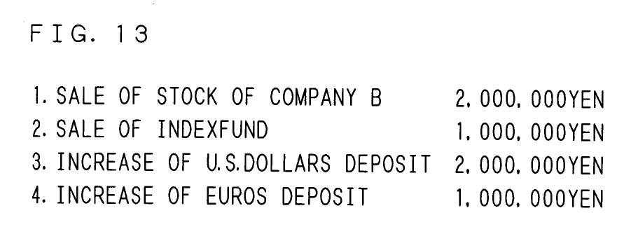

FIG. 13 is a view showing the order of updating from the current portfolio shown in FIG. 7 to the incoming portfolio shown in FIG. 8 of the portfolio generation support system according to Embodiment 2 of the present invention. As shown in the figure, the order of updating from the current portfolio to the incoming portfolio can be clearly specified on the basis of cash flow standpoint, maximization of the marginal gain, minimization of the marginal loss and the like.

That is, in the example shown in FIG. 13, the order of an updating process can be decided for each type of a financial product so that the current portfolio is updated to the incoming portfolio in the order of (1) sale of stock, (2) cancellation of investment trust, (3) increase of liquidity deposit and (4) increase of illiquidity deposit.

When the order of priority of the updating process for each type of a financial product is specified, the relay computer 7 specifies a financial product subject to trading for each financial product type so that the marginal gain obtained by trading is maximized and the marginal loss is minimized. In the example shown in FIG. 13, regarding the sale of stock, the opportunity loss amount, i.e. the assumed marginal loss, can be minimized when a stock name of lower rating is sold earlier. Consequently, it can be specified that the stock of the company B is to be sold first. On the other hand, regarding the purchase of stock, it is expected that the assumed marginal gain is maximized when a stock name of higher rating is purchased earlier.

Moreover, regarding the increase of the liquidity deposit, the assumed marginal gain can be maximized when a financial product of a higher interest is increased earlier. In the example shown in FIG. 13, it can be specified that the U.S. dollars deposit is to be increased. On the other hand, regarding the decrease of the liquidity deposit, the assumed marginal loss can be minimized when a liquidity deposit of a lower interest is decreased earlier.

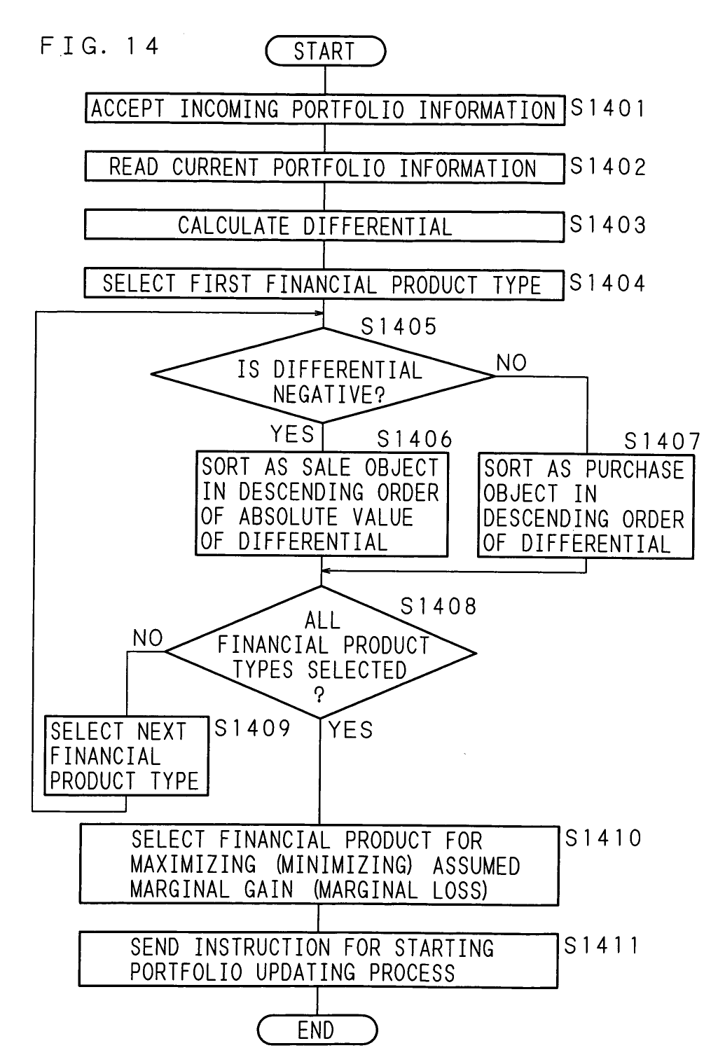

FIG. 14 is a view showing the process procedure of the CPU 71 of the relay computer 7 in the portfolio generation support system according to Embodiment 2 of the present invention. The CPU 71 of the relay computer 7 accepts incoming portfolio information for specifying what type of financial product among one or a plurality of financial products to be provided by the dealer computers 8, 8, . . . is desired to be used for generating a portfolio (step S1401). The incoming portfolio information is not limited to the component ratio of each type of financial product described above, but may be any information on a condition capable of specifying the structure of the portfolio.

The CPU 71 reads current portfolio information from the storage means 72 (step S1402) and calculates a differential between the read current portfolio information and the accepted incoming portfolio information for each type of financial product (step S1403).

The CPU 71 selects the first financial product type which composes the incoming portfolio (step S1404) and judges whether the calculated differential is a negative value or not (step S1405). When the CPU 71 judges that the calculated differential is a negative value (step S1405: YES), the financial product type is sorted on the RAM 73 as an object of sale in descending order of the absolute value of the differential (step S1406).

When the CPU 71 judges that the calculated differential is a positive value (step S1405: NO), the financial product type is sorted on the RAM 73 as an object of purchase in descending order of the differential (step S1407).

The CPU 71 judges whether all the financial product types included in the incoming portfolio have been selected or not (step S1408), and when the CPU 71 judges that some financial product types included in the incoming portfolio have not been selected (step S1408: NO), the CPU 71 selects a financial product type which has not been selected (step S1409) and returns to the step S1405.

When the CPU 71 judges that all the financial product types included in the incoming portfolio have been selected (step S1408: YES), the CPU 71 selects a financial product for maximizing (minimizing) the assumed marginal gain (marginal loss) for each financial product type (step S1410) and sends an instruction for starting a portfolio updating process to the user computer 5 (step S1411).

As described above, with this Embodiment 2, in addition to updating the combination of financial products which compose an incoming portfolio desired by the user of the user computer 5, it is enabled to decide the order of updating of the combination of the financial products which compose the portfolio so that the assumed marginal gain is maximized and the assumed marginal loss is minimized.

It should be noted that what type of financial product among a plurality of financial products is to be prioritized for performing a trading process involved in portfolio updating on what condition is not limited to the above example, but incoming portfolio information may be accepted from the user computer 5 or the storage means 72 may store portfolio information 722 which is a sample portfolio of a plurality of combined financial products so that the user of the user computer 5 may select a sample portfolio most similar to the one he desires.

### Embodiment 3

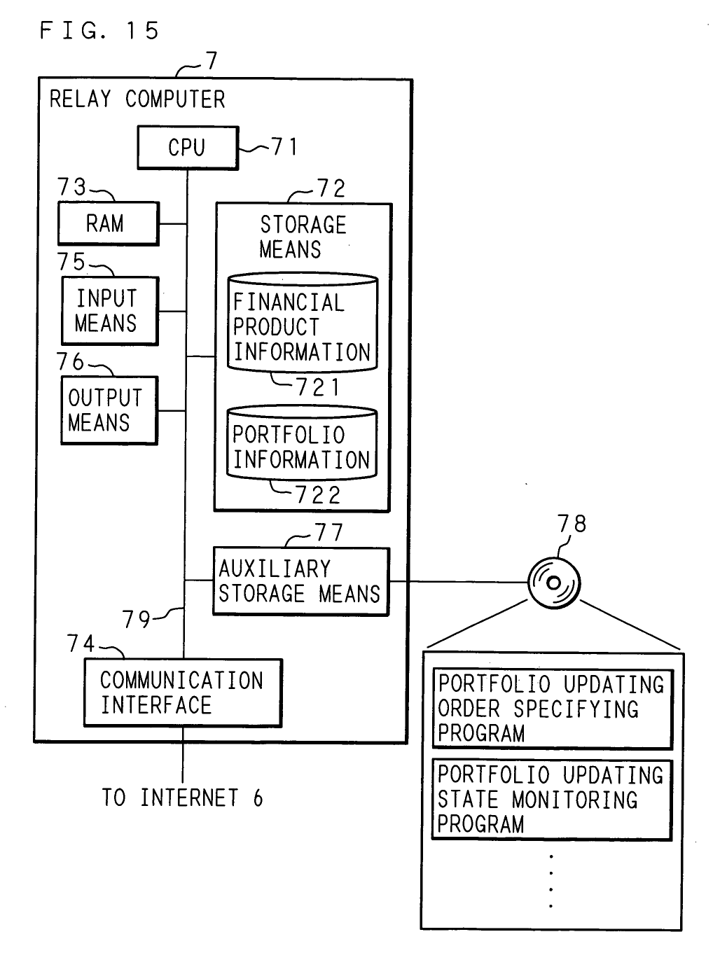

The following description will explain a portfolio generation support system according to Embodiment 3 of the present invention in the concrete with reference to the drawings. FIG. 15 is a block diagram showing the structure of a relay computer 7 in the portfolio generation support system according to Embodiment 3 of the present invention. The components having the same functions as those of the portfolio generation support system according to Embodiment 2 are denoted with the same codes and the detailed explanation thereof will be omitted. The Embodiment 3 is characterized in that a monitoring condition at portfolio updating time is generated on the basis of a differential between a current portfolio and an incoming portfolio and the portfolio updating state is monitored with an updating state monitoring program.

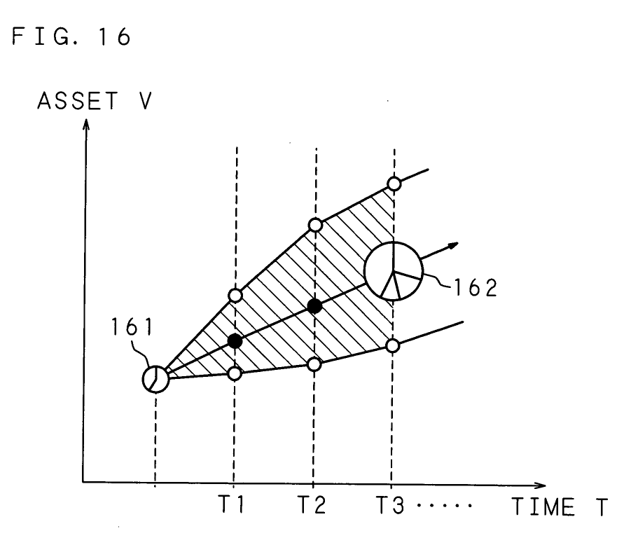

FIG. 16 is a conceptual diagram of an updating model from a current portfolio to a target incoming portfolio. When updating a current portfolio 161 to an incoming portfolio 162, the variation width of an asset V varies according to trading timing. Consequently, whether updating to the incoming portfolio succeeds or not can be judged by simulating the variation of the asset V in the course of updating from the current portfolio 161 to the incoming portfolio 162 as a function of time T and monitoring whether a predetermined threshold value is exceeded or not in each given monitoring cycle.

The simulation of updating to the target portfolio can be obtained by performing variation simulations of the asset for each financial product on the basis of the differential data of the current portfolio and the incoming portfolio and adding the variation simulation result along the time axis. In FIG. 16, the simulation results at times T1, T2, T3, . . . are denoted by black circles. The monitoring condition based on the variation width of the asset V is given at monitoring times T1, T2, T3, . . . and it can be seen that the updating to the incoming portfolio is proceeding smoothly within the area denoted by the white circles in FIG. 16, i.e., when the asset V against the time axis is within the shaded area. To the contrary, it can be seen that the updating to the incoming portfolio is not proceeding smoothly and a review of the portfolio plan or the like is necessary when the asset V against the time axis is outside the shaded area.

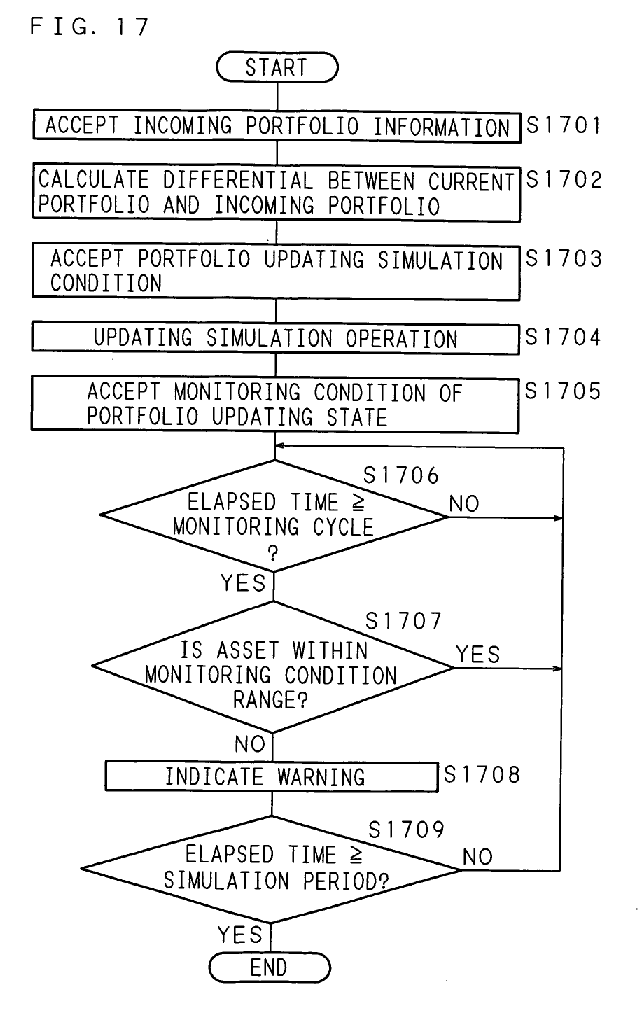

FIG. 17 is a view showing the process procedure of the CPU 71 of the relay computer 7 in the portfolio generation support system according to Embodiment 3 of the present invention. The CPU 71 of the relay computer 7 accepts incoming portfolio information for specifying what type of financial product among one or a plurality of financial products to be provided by the dealer computers 8, 8, . . . is desired to be used for generating a portfolio (step S1701). The CPU 71 calculates a differential between the current portfolio and the incoming portfolio (step S1702) and accepts a portfolio updating simulation condition such as a simulation period, a monitoring cycle and the number of monitoring times (step S1703).

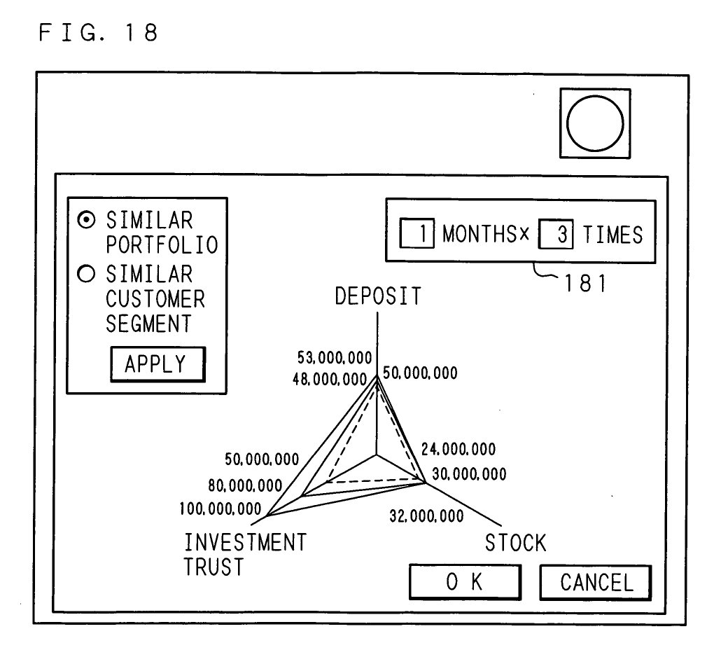

FIG. 18 is a view illustrating a screen for accepting a portfolio updating simulation condition. In FIG. 18, a similar portfolio is applied as a portfolio model and a radar chart is shown for deposit, stock and investment trust as financial products. The user inputs the monitoring cycle and the number of monitoring times at a monitoring condition input area 181. The upper limit and the lower limit of the variation width of the asset V may be inputted as the portfolio updating simulation condition. The CPU 71 employs the product of the monitoring cycle and the number of monitoring times as a simulation period in order to perform an updating simulation operation to the target incoming portfolio (step S1704).

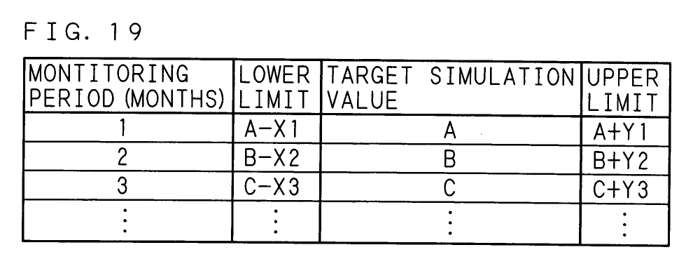

The CPU 71 accepts a monitoring condition of the portfolio updating state (step S1705). FIG. 19 is a view illustrating a monitoring condition of the portfolio updating state. As shown in FIG. 19, for each monitoring cycle, the simulation result of updating to the target incoming portfolio and the upper limit range and the lower limit range thereof are set. It should be understood that the upper limit and the lower limit calculated as the simulation result may be applied as the monitoring condition when the upper limit and the lower limit of the variation width of the asset V are inputted as the portfolio updating simulation condition.

The CPU 71 measures the elapsed time since the start of a portfolio updating process and judges whether the elapsed time has reached the monitoring cycle or not (step S1706). When the CPU 71 judges that the elapsed time has reached the monitoring cycle (step S1706: YES), the CPU 71 judges whether the asset V at this time point is within the monitoring condition range or not (step S1707).

When the CPU 71 judges that the asset V is within the monitoring condition range (step S1707: YES), it is judged that the portfolio updating process is proceeding according to plan and the CPU 71 returns the process to the step S1706. When the CPU 71 judges that the asset V is outside the monitoring condition range (step S1707: NO), the CPU 71 judges that the portfolio updating process is not proceeding according to plan and indicates the situation to the user in order to give warning (step S1708).

The CPU 71 judges whether the elapsed time has reached the accepted simulation period or not (step S1709), and when the CPU 71 judges that the elapsed time has not reached the accepted simulation period (step S1709: NO), the CPU 71 returns to the step S1706 and repeatedly performs the process described above.

Moreover, instead of newly generating a monitoring condition, a monitoring condition may be set for each sample portfolio stored as portfolio information 722 in the storage means 72 for each component ratio of each typical financial product type so as to extract and apply the monitoring condition stored as the portfolio information 722 corresponding to the similarity between the sample portfolio and the incoming portfolio.

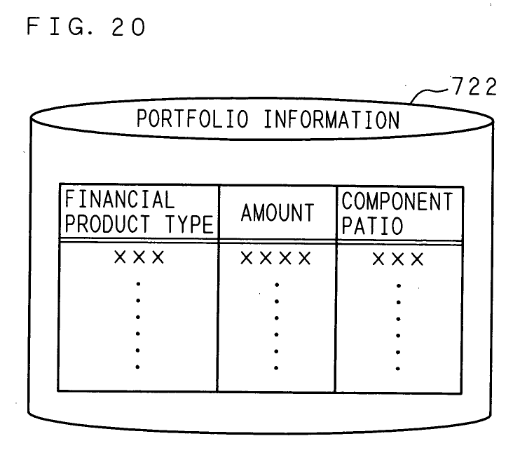

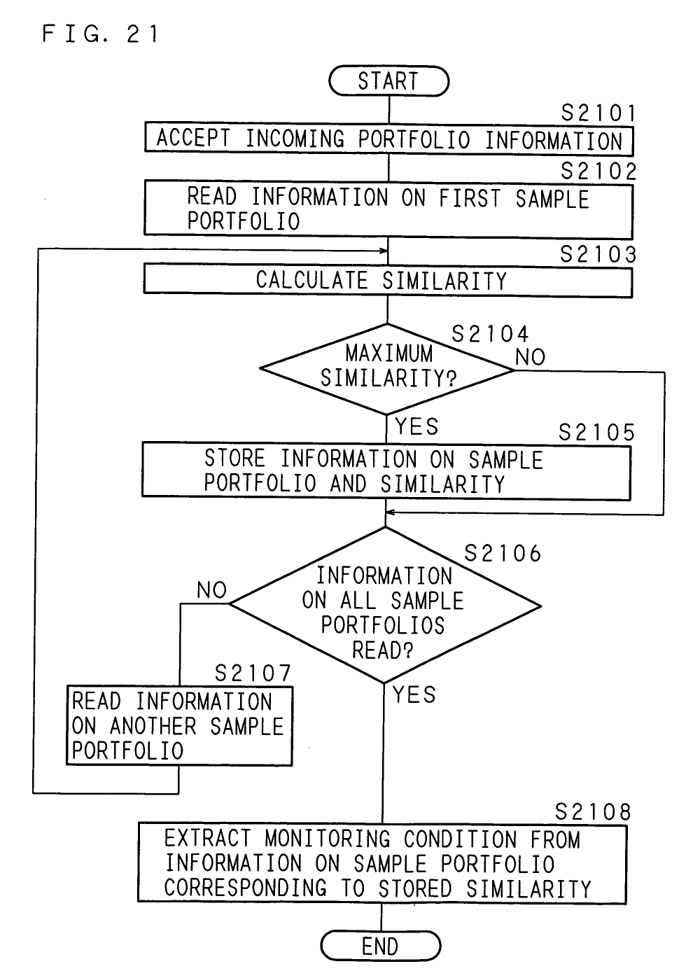

FIG. 20 is a view showing an example of the portfolio information 722 stored in the storage means 72 in the portfolio generation support system according to Embodiment 3 of the present invention; and FIG. 21 is a flow chart showing the process procedure of the CPU 71 of the relay computer 7 in the portfolio generation support system according to Embodiment 3 of the present invention for specifying a monitoring condition on the basis of the similarity. As shown in FIG. 20, the amount, the component ratio and the monitoring condition are stored as the portfolio information 722 for each financial product type as a sample portfolio.

As shown in FIG. 21, the CPU 71 of the relay computer 7 accepts incoming portfolio information for specifying what type of financial product among one or a plurality of financial products to be provided by the dealer computers 8, 8, . . . is desired to be used for generating a portfolio (step S2101). Similarly to Embodiment 2, the incoming portfolio information is not limited to the component ratio of each type of the financial product, but may be any information on a condition capable for specifying the structure of a portfolio.

The CPU 71 reads information on the first sample portfolio from the storage means 72 (step S2102) and calculates the similarity between the read information and the accepted incoming portfolio information (step S2103).

For example, when calculating the similarity between a sample portfolio having component ratio of each financial product type of liquidity deposit 65%, illiquidity deposit 10%, stock 10% and investment trust 15% and the incoming portfolio shown in FIG. 8, the similarity is calculated for each financial product and the entire similarity is calculated by multiplying all the similarities of financial products. That is, the similarity is calculated as 1.23 on the basis of (60/65) for liquidity deposit, (20/10) for illiquidity deposit, (10/10) for stock and (10/15) for investment trust. The information necessary for calculating the similarity between the stored sample portfolio and the incoming portfolio is not limited to this, but customer information, market information or the like may be added.

The CPU 71 judges whether the calculated similarity is larger than the similarity stored in the RAM 73 or not, i.e., whether the calculated similarity is the maximum or not (step S2104). When the CPU 71 judges that the calculated similarity is the maximum (step S2104: YES), the CPU 71 stores the information on a corresponding sample portfolio and the calculated similarity in the RAM 73 (step S2105) and judges whether information on all the sample portfolios has been read or not (step S2106). When the CPU 71 judges that the calculated similarity is not the maximum (step S2104: NO), the CPU 71 goes to the step S2106 without storing the calculated similarity in the RAM 73.

When the CPU 71 judges that information on some sample portfolios has not been read (step S2106: NO), the CPU 71 reads information on a sample portfolio which has not been read (step S2107) and returns to the step S2103.

When the CPU 71 judges that information on all the sample portfolios has been read (step S2106: YES), the CPU 71 extracts a monitoring condition from information on a sample portfolio corresponding to the similarity stored in the RAM 73 (step S2108).

In this manner, by grasping the degree of transition to the incoming portfolio using a monitoring condition stored in relation to the sample portfolio most similar to the incoming portfolio among sample portfolios preliminarily stored as a monitoring condition for judging whether the incoming portfolio can be realized or not, it is unnecessary to calculate a complex monitoring condition again and whether updating to the incoming portfolio is possible or not can be judged while reducing the used amount of the computer resources such as a CPU or a memory.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A servicer linkage system comprising:
a plurality of service providing computers for providing one or a plurality of services;
a service receiving computer which selects a service to be provided and receives the service; and
a relay computer which is connected with the plurality of service providing computers and the service receiving computer so as to transmit and receive data via communication means, wherein
the relay computer comprises:
means for storing in storage means first context data for each service receiving computer including types and a combination of the services selected by the service receiving computer at a predetermined time point;
means for accepting from the service receiving computer second context data including types and a combination of target services;
means for calculating differential data of the, first context data and the second context data; and
means for specifying an order of updating of a service included in the first context data to a service included in the second context data, on the basis of the calculated differential data.

2. A servicer linkage system comprising:
a plurality of service providing computers for providing one or a plurality of services;
a service receiving computer which selects a service to be provided and receives the service; and
a relay computer which is connected with the plurality of service providing computers and the service receiving computer so as to transmit and receive data via communication means, wherein
the relay computer comprises a processor capable of performing the following operation of:
storing in storage means first context data for each service receiving computer including types and a combination of the services selected by the service receiving computer at a predetermined time point;
accepting from the service receiving computer second context data including types and a combination of target services;
calculating differential data of the first context data and the second context data; and
specifying an order of updating of a service included in the first context data to a service included in the second context data, on the basis of the calculated differential data.

3. A relay computer, which is connected with an outer computer so as to transmit and receive data via communication means, comprising:
means for storing in storage means first context data for each outer computer including types and a combination of services selected by the outer computer at a predetermined time point;
means for accepting from the outer computer second context data including types and a combination of target services;
means for calculating differential data of the first context data and the second context data; and
means for specifying an order of updating of a service included in the first context data to a service included in the second context data, on the basis of the calculated differential data.

4. A relay computer, which is connected with an outer computer so as to transmit and receive data via communication means, comprising a processor capable of performing the following operations of:
storing in storage means first context data for each outer computer including types and a combination of services selected by the outer computer at a predetermined time point;
accepting from the outer computer second context data including types and a combination of target services;
calculating differential data of the first context data and the second context data; and
specifying an order of updating of a service included in the first context data to a service included in the second context data, on the basis of the calculated differential data.

5. A portfolio generation support system comprising:
a plurality of dealer computers for providing one or a plurality of financial products;
a user computer for accepting an instruction for selecting a financial product to be provided and making a trade; and
a relay computer which is connected with the plurality of dealer computers and the user computer so as to transmit and receive data via communication means, wherein
the relay computer comprises:
means for storing in storage means first financial product information for each user computer including information for sorting a financial product selected at a predetermined time point, and an amount and a component ratio of said financial product;
means for accepting from the user computer second financial product information including information for sorting a target financial product, an amount and a component ratio of the target financial product;
means for calculating differential data of the first financial product information and the second financial product information; and
means for specifying an order of updating of a financial product included in the first financial product information to a financial product included in the second financial product information, on the basis of the calculated differential data.

6. The portfolio generation support system according to claim 5, wherein
the relay computer further comprises:
means for generating a monitoring condition for monitoring state transition from the first financial product information to the second financial product information on the basis of the differential data; and
means for storing the monitoring condition generated by said means in relation to the second financial product information.

7. The portfolio generation support system according to claim 5, wherein
the relay computer stores in storage means third financial product information including information for sorting a plurality of financial products, and an amount and a component ratio of each of the financial products, in relation to the monitoring condition, and further comprises:
means for calculating a similarity between each of a plurality of pieces of stored third financial product information and the second financial product information;
means for extracting a monitoring condition stored in relation to a piece of third financial product information having the highest similarity; and
means for storing the monitoring condition extracted by said means in relation to the second financial product information.

8. The portfolio generation support system according to claim 5, wherein the information for sorting the financial product includes distinction between illiquidity asset and liquidity asset and an indicator of a degree of cashability of the liquidity asset.

9. The portfolio generation support system according to claim 6, wherein the information for sorting the financial product includes distinction between illiquidity asset and liquidity asset and an indicator of a degree of cashability of the liquidity asset.

10. The portfolio generation support system according to claim 7, wherein the information for sorting the financial product includes distinction between illiquidity asset and liquidity asset and an indicator of a degree of cashability of the liquidity asset.

11. A portfolio generation support system comprising:
a plurality of dealer computers for providing one or a plurality of financial products;
a user computer for accepting an instruction for selecting a financial product to be provided and making a trade; and
a relay computer which is connected with the plurality of dealer computers and the user computer so as to transmit and receive data via communication means, wherein
the relay computer comprises a processor capable of performing the following operations of:
storing in storage means first financial product information for each user computer including information for sorting a financial product selected at a predetermined time point, and an amount and a component ratio of said financial product;
accepting from the user computer second financial product information including information for sorting a target financial product, and an amount and a component ratio of the target financial product;
calculating differential data of the first financial product information and the second financial product information; and
specifying an order of updating of a financial product included in the first financial product information to a financial product included in the second financial product information, on the basis of the calculated differential data.

12. The portfolio generation support system according to claim 11, wherein
the relay computer comprises a processor capable of further performing the following operations of:
generating a monitoring condition for monitoring state transition from the first financial product information to the second financial product information on the basis of the differential data; and
storing the generated monitoring condition in relation to the second financial product information.

13. The portfolio generation support system according to claim 11, wherein
the relay computer stores in storage means third financial product information including information for sorting a financial product, and an amount and a component ratio of each of the financial products, in relation to the monitoring condition, and comprises a processor capable of further performing the following operations of:
calculating a similarity between each of a plurality of pieces of stored third financial product information and the second financial product information;
extracting a monitoring condition stored in relation to a piece of third financial product information having the highest similarity; and
storing the extracted monitoring condition in relation to the second financial product information.

14. The portfolio generation support system according to claim 11, wherein the information for sorting the financial product includes distinction between illiquidity asset and liquidity asset and an indicator of a degree of cashability of the liquidity asset.

15. The portfolio generation support system according to claim 12, wherein the information for sorting the financial product includes distinction between illiquidity asset and liquidity asset and an indicator of a degree of cashability of the liquidity asset.

16. The portfolio generation support system according to claim 13, wherein the information for sorting the financial product includes distinction between illiquidity asset and liquidity asset and an indicator of a degree of cashability of the liquidity asset.

17. A relay computer, which is connected with an outer computer so as to transmit and receive data via communication means, comprising:
means for storing in storage means first financial product information for each outer computer including information for sorting a financial product selected at a predetermined time point, and an amount and a component ratio of said financial product;
means for accepting from the outer computer second financial product information including information for sorting a target financial product, and an amount and a component ratio of the target financial product;
means for calculating differential data of the first financial product information and the second financial product information; and
means for specifying an order of updating of a financial product included in the first financial product information to a financial product included in the second financial product information, on the basis of the calculated differential data.

18. The relay computer according to claim 17, further comprising:
means for generating a monitoring condition for monitoring state transition from the first financial product information to the second financial product information on the basis of the differential data; and
means for storing the monitoring condition generated by said means in relation to the second financial product information.

19. The relay computer according to claim 18, storing in storage means third financial product information including information for sorting a plurality of financial products, and an amount of and a component ratio of each of the financial products, in relation to a monitoring condition for monitoring state transition from the first financial product information to the second financial product information, and further comprising:
means for calculating a similarity between each of a plurality of pieces of stored third financial product information and the second financial product information;
means for extracting a monitoring condition stored in relation to a piece of third financial product information having the highest similarity; and
means for storing the monitoring condition extracted by said means in relation to the second financial product information.

20. The relay computer according to claim 17, wherein the information for sorting the financial product includes distinction between illiquidity asset and liquidity asset and an indicator of a degree of cashability of the liquidity asset.

21. The relay computer according to claim 18, wherein the information for sorting the financial product includes distinction between illiquidity asset and liquidity asset and an indicator of a degree of cashability of the liquidity asset.

22. The relay computer according to claim 19, wherein the information for sorting the financial product includes distinction between illiquidity asset and liquidity asset and an indicator of a degree of cashability of the liquidity asset.

23. A relay computer, which is connected with an outer computer so as to transmit and receive data via communication means, comprising a processor capable of performing the following operations of:
storing in storage means first financial product information for each outer computer including information for sorting a financial product selected at a predetermined time point, and an amount and a component ratio of said financial product;
accepting from the outer computer second financial product information including information for sorting a target financial product, and an amount and a component ratio of the target financial product;
calculating differential data of the first financial product information and the second financial product information; and
specifying an order of updating of a financial product included in the first financial product information to a financial product included in the second financial product information, on the basis of the calculated differential data.

24. The relay computer according to claim 23, comprising a processor capable of further performing the following operations of:
generating a monitoring condition for monitoring state transition from the first financial product information to the second financial product information on the basis of the differential data; and
storing the generated monitoring condition in relation to the second financial product information.

25. The relay computer according to claim 24, storing in storage means third financial product information including information for sorting a plurality of financial products, and an amount and a component ratio of each of the financial products, in relation to a monitoring condition for monitoring state transition from the first financial product information to the second financial product information, and comprising a processor capable of further performing the following operations of:
calculating a similarity between each of a plurality of pieces of stored third financial product information and the second financial product information;
extracting a monitoring condition stored in relation to a piece of third financial product information having the highest similarity; and
storing the extracted monitoring condition in relation to the second financial product information.

26. The relay computer according to claim 23, wherein the information for sorting the financial product includes distinction between illiquidity asset and liquidity asset and an indicator of a degree of cashability of the liquidity asset.

27. The relay computer according to claim 24, wherein the information for sorting the financial product includes distinction between illiquidity asset and liquidity asset and an indicator of a degree of cashability of the liquidity asset.

28. The relay computer according to claim 25, wherein the information for sorting the financial product includes distinction between illiquidity asset and liquidity asset and an indicator of a degree of cashability of the liquidity asset.

29. A portfolio generation support method for allowing a relay computer to transmit and receive data via communication means to and from a dealer computer for providing one or a plurality of financial products and a user computer for accepting an instruction for selecting a financial product to be provided and making a trade, comprising the steps of:
storing in storage means first financial product information for each user computer including information for sorting a financial product selected at a predetermined time point, and an amount and a component ratio of said financial product;
accepting from the user computer second financial product information including information for sorting a target financial product, and an amount and a component ratio of the target financial product;
calculating differential data of the first financial product information and the second financial product information; and
specifying an order of updating of a financial product included in the first financial product information to a financial product included in the second financial product information, on the basis of the calculated differential data.

30. The portfolio generation support method according to claim 29, further comprising the steps of:
generating a monitoring condition for monitoring state transition from the first financial product information to the second financial product information on the basis of the differential data; and
storing the generated monitoring condition in relation to the second financial product information.

31. The portfolio generation support method according to claim 29, further comprising the steps of:
storing in storage means third financial product information including information for sorting a plurality of financial products, and an amount and a component ratio of each of the financial products, in relation to a monitoring condition for monitoring state transition from the first financial product information to the second financial product information:
calculating a similarity between each of a plurality of pieces of stored third financial product information and the second financial product information;
extracting a monitoring condition stored in relation to a piece of third financial product information having the highest similarity; and
storing the extracted monitoring condition in relation to the second financial product information.

32. The portfolio generation support method according to claim 29, wherein the information for sorting the financial product includes distinction between illiquidity asset and liquidity asset and an indicator of a degree of cashability of the liquidity asset.

33. The portfolio generation support method according to claim 30, wherein the information for sorting the financial product includes distinction between illiquidity asset and liquidity asset and an indicator of a degree of cashability of the liquidity asset.

34. The portfolio generation support method according to claim 31, wherein the information for sorting the financial product includes distinction between illiquidity asset and liquidity asset and an indicator of a degree of cashability of the liquidity asset.

35. A recording medium storing a computer program for a relay computer which is connected with a plurality of dealer computers for providing one or a plurality of financial products and a user computer which accepts an instruction for selecting a financial product to be provided and making a trade so as to transmit and receive data via communication means, wherein
the computer program stored in the recording medium comprises the steps of:
causing the relay computer to store in storage means financial product information for each user computer including information for sorting a financial product selected at a predetermined time point, and an amount and a component ratio of said financial product;
causing the relay computer to accept from the user computer second financial product information including information for sorting a target financial product, and an amount and a component ratio of the target financial product;
causing the relay computer to calculate differential data of the first financial product information and the second financial product information; and
causing the relay computer to specify an order of updating of a financial product included in the first financial product information to a financial product included in the second financial product information, on the basis of the calculated differential data.

36. The recording medium according to claim 35, storing the computer program which further comprises the steps of:
causing the relay computer to generate a monitoring condition for monitoring state transition from the first financial product information to the second financial product information on the basis of the differential data; and
causing the relay computer to store the generated monitoring condition in relation to the second financial product information.

37. The recording medium according to claim 36, storing the computer program which can be executed by the relay computer, wherein
the relay computer stores in storage means third financial product information including information for sorting a plurality of financial products, and an amount and a component ratio of each of the financial products, in relation to a monitoring condition for monitoring state transition from the financial product information to the second financial product information, and
the computer program further comprises the steps of causing the relay computer to:
calculate a similarity between each of a plurality of pieces of stored third financial product information and the second financial product information;
extract a monitoring condition stored in relation to a piece of third financial product information having the highest similarity; and
store the extracted monitoring condition in relation to the second financial product information.

38. The recording medium according to claim 35, storing the computer program which can be executed by the relay computer, wherein the information for sorting the financial product includes distinction between illiquidity asset and liquidity asset and an indicator of a degree of cashability of the liquidity asset.

39. The recording medium according to claim 36, storing the computer program which can be executed by the relay computer, wherein the information for sorting the financial product includes distinction between illiquidity asset and liquidity asset and an indicator of a degree of cashability of the liquidity asset.

40. The recording medium according to claim 37, storing the computer program which can be executed by the relay computer, wherein the information for sorting the financial product includes distinction between illiquidity asset and liquidity asset and an indicator of a degree of cashability of the liquidity asset.
